(19) United States
(12) Patent Application Publication
(10) Pub. No.: US 2021/0068366 A1
(43) Pub. Date: Mar. 11, 2021

(54) Collapsible Dish Assembly

(71) Applicant: Damian Tellepsen, Houston, TX (US)

(72) Inventor: Damian Tellepsen, Houston, TX (US)

(21) Appl. No.: 16/562,081

(22) Filed: Sep. 5, 2019

(51) Int. Cl. A01K 7/00; B65D 21/08

(52) U.S. Cl. CPC A01K 7/00; A01K 27/001; B65D 21/086

(57) ABSTRACT

A collapsible dish assembly for carrying a water dish on a collar of an animal includes a dish that has a plurality of collapsible sections. The dish is positionable in a flattened position. Additionally, the dish is positionable in an expanded position to contain water. A coupler is coupled to the dish and the coupler engages a collar on an animal when the dish is in the collapsed position. In this way the dish can be suspended from the collar for transporting the dish.

### CROSS-REFERENCE TO RELATED APPLICATIONS

### STATEMENT REGARDING FEDERALLY SPONSORED RESEARCH OR DEVELOPMENT

Not Applicable

### (d) THE NAMES OF THE PARTIES TO A JOINT RESEARCH AGREEMENT Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to dish device and more particularly pertains to a new dish device for carrying a water dish on a collar of an animal.

### BRIEF SUMMARY OF THE INVENTION

An embodiment of the disclosure meets the needs presented above by generally comprising a dish that has a plurality of collapsible sections. The dish is positionable in a flattened position. Additionally, the dish is positionable in an expanded position to contain water. A coupler is coupled to the dish and the coupler engages a collar on an animal when the dish is in the collapsed position. In this way the dish can be suspended from the collar for transporting the dish.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a collapsible dish assembly according to an embodiment of the disclosure.

FIG. 2 is a front view of an embodiment of the disclosure showing a dish in an extended position.

FIG. 3 is a top view of an embodiment of the disclosure.

FIG. 4 is a perspective view of an embodiment of the disclosure showing a dish in a flattened position.

FIG. 5 is a perspective in-use view of an embodiment of the disclosure.

### DETAILED DESCRIPTION OF THE INVENTION

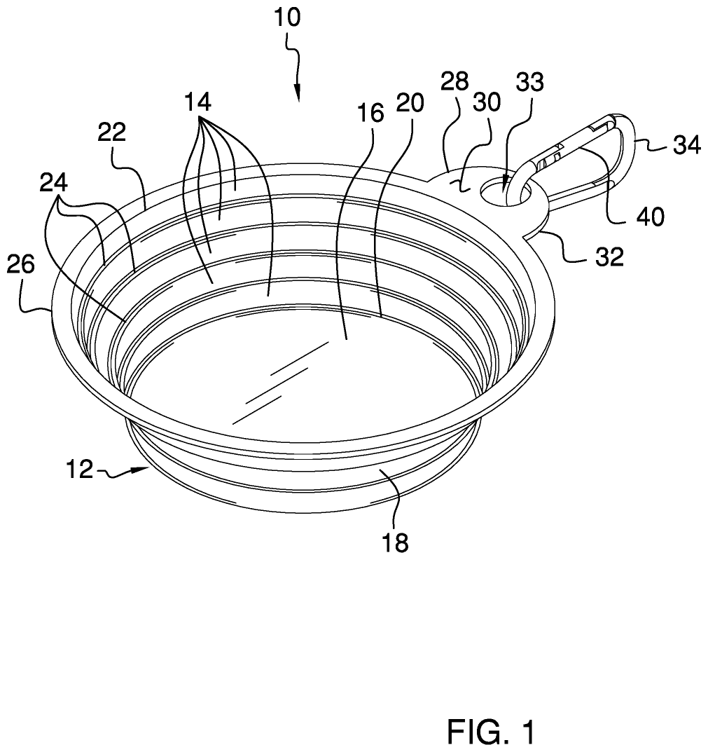

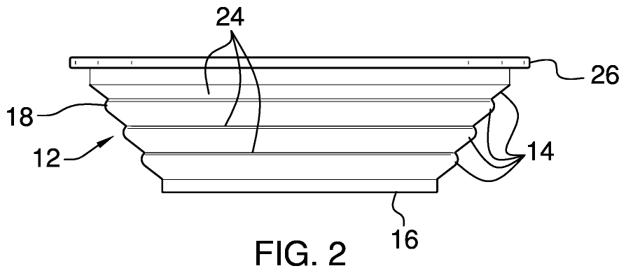

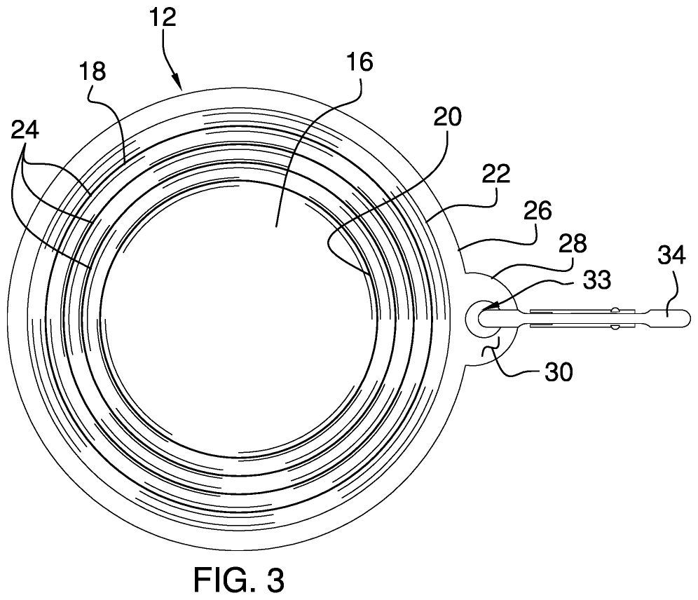

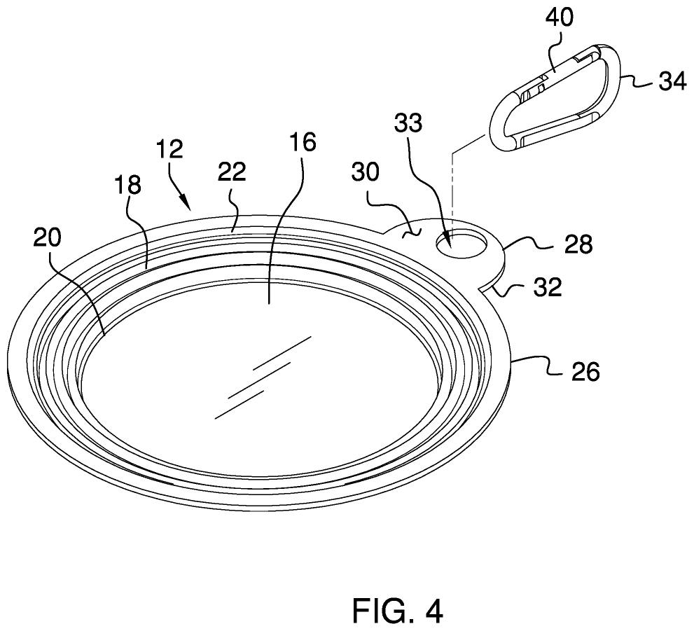

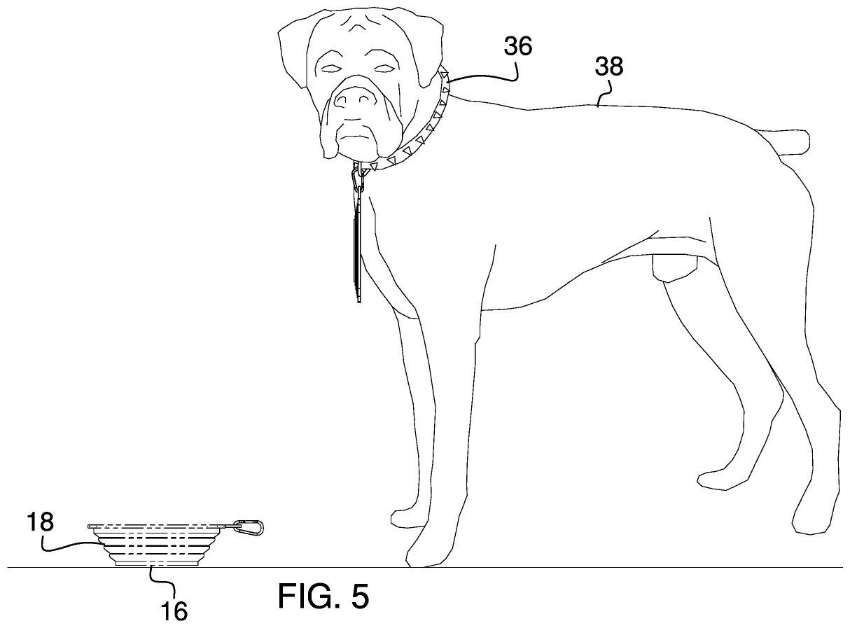

With reference now to the drawings, and in particular to FIGS. 1 through 5 thereof, a new dish device embodying the principles and concepts of an embodiment of the disclosure and generally designated by the reference numeral 10 will be described.

As best illustrated in FIGS. 1 through 5, the collapsible dish assembly 10 generally comprises a dish 12 that has a plurality of collapsible sections 14. The dish 12 is positionable in a flattened position. Additionally, the dish 12 is positionable in an expanded position thereby facilitating the dish 12 to contain water. The dish 12 is comprised of a fluid impermeable material such as rubber or the like.

The dish 12 has a basal wall 16 and an outer wall 18 extending upwardly therefrom. The basal wall 16 has a perimeter edge 20 and the perimeter edge 20 is continuously arcuate about a center point of the basal wall 16 such that the basal wall 16 forms a disk. The outer wall 18 is coextensive with the perimeter edge 20. The outer wall 18 has a distal edge 22 with respect to the basal wall 16. The outer wall 18 has a plurality of fold lines 24 and each of the fold lines 24 extends around an entire circumference of the outer wall 18. The fold lines 24 are spaced apart from each other and are distributed between the basal wall 16 and the distal edge 22 of the outer wall 18. Moreover, the spaces between each of the fold lines 24 define the plurality of collapsible sections 14.

The outer wall 18 is collapsed at each of the fold lines 24 having the distal edge 22 being aligned with a top surface 30 of the basal wall 16. The outer wall 18 is expandable at each of the fold lines 24 having the distal edge 22 being spaced from the top surface 30 of the basal wall 16. The outer wall 18 angles outwardly from the perimeter edge 20 of the basal wall 16. Thus, the distal edge 22 of the outer wall 18 forms a circle which has a circumference being greater than a circumference of the basal wall 16.

A lip 26 is coupled to and extends laterally away from the outer wall 18. The lip 26 is coextensive with the distal edge 22 of the outer wall 18. An engagement 28 extends away from the lip 26. The engagement 28 has a top surface 30 and a bottom surface 32, and the engagement 28 has an aperture 33 extending through said top surface 30 and the bottom surface 32.

A coupler 34 is provided and the coupler 34 engages the engagement 28 such that the coupler 34 is coupled to the dish 12. The coupler 34 engages a collar 36 on an animal 38 when the dish 12 is in the collapsed position. In this way the dish 12 can be suspended from the collar 36 for transporting the dish 12. The animal 38 may be a domesticated dog or other domesticated animal. The coupler 34 has a gate 40 that is positionable between an open position and a closed position. The coupler 34 is extendable through the engagement 28 when the gate is in the open position. Additionally, the coupler 34 is retained on the engagement 28 when the gate is in the closed position. The coupler 34 may comprise a D-ring, a lobster claw clamp or any other type of mechanical coupler 34 that forms a closed loop when closed.

In use, the dish 12 is positioned in the closed position and the coupler 34 is coupled to the collar 36 on the animal 38. In this way the dish 12 is carried on the animal 38 wherever the animal 38 goes. The coupler 34 is uncoupled from the collar 36 and the dish 12 is positioned in the expanded position. In this way the dish 12 can be filled with water for the animal 38 to drink. Thus, the animal 38 can drink water wherever the animal 38 goes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collapsible dish assembly being configured to be worn on a collar of an animal thereby facilitating the animal to be watered at a remote location, said assembly comprising:
a dish having a plurality of collapsible sections, said dish being positionable in a flattened position, said dish being positionable in an expanded position wherein said dish is configured to contain water; and
a coupler being coupled to said dish, said coupler engaging a collar on an animal when said dish is in said collapsed position wherein said dish is configured to be suspended from the collar for transporting said dish.

2. The assembly according to claim 1, wherein said dish has a basal wall and an outer wall extending upwardly therefrom, said basal wall having a perimeter edge, said perimeter edge being continuously arcuate about a center point of said basal wall such that said basal wall forms a disk, said outer wall being coextensive with said perimeter edge, said outer wall having a distal edge with respect to said basal wall, said outer wall having a plurality of fold lines, each of said fold lines extending around an entire circumference of said outer wall, said fold lines being spaced apart from each other and being distributed between said basal wall and said distal edge of said outer wall to define said plurality of collapsible sections.

3. The assembly according to claim 2, wherein said outer wall is collapsed at each of said fold lines having said distal edge being aligned with a top surface of said basal wall.

4. The assembly according to claim 3, wherein said outer wall is expandable at each of said fold lines having said distal edge being spaced from said top surface of said basal wall.

5. The assembly according to claim 4, wherein said outer wall angles outwardly from said perimeter edge of said basal wall such that said distal edge of said outer wall forms a circle having a circumference being greater than a circumference of said basal wall.

6. The assembly according to claim 2, further comprising:
a lip being coupled to and extending laterally away from said outer wall, said lip being coextensive with said distal edge of said outer wall; and
an engagement extending away from said lip.

7. The assembly according to claim 6, wherein said coupler has a gate being positionable between an open position and a closed position, said coupler being extendable through said engagement when said gate is in said open position, said coupler being retained on said engagement when said gate is in said closed position.

8. A collapsible dish assembly being configured to be worn on a collar of an animal thereby facilitating the animal to be watered at a remote location, said assembly comprising:
a dish having a plurality of collapsible sections, said dish being positionable in a flattened position, said dish being positionable in an expanded position wherein said dish is configured to contain water, said dish having a basal wall and an outer wall extending upwardly therefrom, said basal wall having a perimeter edge, said perimeter edge being continuously arcuate about a center point of said basal wall such that said basal wall forms a disk, said outer wall being coextensive with said perimeter edge, said outer wall having a distal edge with respect to said basal wall, said outer wall having a plurality of fold lines, each of said fold lines extending around an entire circumference of said outer wall, said fold lines being spaced apart from each other and being distributed between said basal wall and said distal edge of said outer wall to define said plurality of collapsible sections, said outer wall being collapsed at each of said fold lines having said distal edge being aligned with a top surface of said basal wall, said outer wall being expandable at each of said fold lines having said distal edge being spaced from said top surface of said basal wall, said outer wall angling outwardly from said perimeter edge of said basal wall such that said distal edge of said outer wall forms a circle having a circumference being greater than a circumference of said basal wall;
a lip being coupled to and extending laterally away from said outer wall, said lip being coextensive with said distal edge of said outer wall;
an engagement extending away from said lip; and
a coupler engaging said engagement such that said coupler is coupled to said dish, said coupler engaging a collar on an animal when said dish is in said collapsed position wherein said dish is configured to be suspended from the collar for transporting said dish, said coupler having a gate being positionable between an open position and a closed position, said coupler being extendable through said engagement when said gate is in said open position, said coupler being retained on said engagement when said gate is in said closed position.
